(19) United States
(12) Patent Application Publication
(10) Pub. No.: US 2017/0070066 A1
(43) Pub. Date: Mar. 9, 2017

(54) Remote Control Assembly

(71) Applicant: Chris Ng, Brooklyn, NY (US)

(72) Inventor: Chris Ng, Brooklyn, NY (US)

(21) Appl. No.: 14/845,911

(22) Filed: Sep. 4, 2015

(51) Int. Cl. H02J 7/00

(52) U.S. Cl. CPC H02J 7/0044; H02J 7/0045; H02J 7/0052

(57) ABSTRACT

A remote control assembly includes a remote unit that may be carried. The remote unit may be in electrical communication with an extrinsic electronic device. The remote unit may be manipulated thereby facilitating the remote unit to wirelessly control functions of the extrinsic electronic device. A base unit is provided and the base unit may have the remote unit is removably positioned thereon. The base unit charges the remote unit when the remote unit is positioned on the base unit.

### BACKGROUND OF THE DISCLOSURE

### Field of the Disclosure

The disclosure relates to control devices and more particularly pertains to a new control device for facilitating enhanced comfort while using a remote control.

### SUMMARY OF THE DISCLOSURE

An embodiment of the disclosure meets the needs presented above by generally comprising a remote unit that may be carried. The remote unit may be in electrical communication with an extrinsic electronic device. The remote unit may be manipulated thereby facilitating the remote unit to wirelessly control functions of the extrinsic electronic device. A base unit is provided and the base unit may have the remote unit is removably positioned thereon. The base unit charges the remote unit when the remote unit is positioned on the base unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a remote control assembly according to an embodiment of the disclosure.

FIG. 2 is a front view of an embodiment of the disclosure.

FIG. 3 is a left side view of an embodiment of the disclosure.

FIG. 4 is a top view of an embodiment of the disclosure.

FIG. 5 is a cross sectional view taken along line 5-5 of FIG. 4 of an embodiment of the disclosure.

### DESCRIPTION OF THE PREFERRED EMBODIMENT

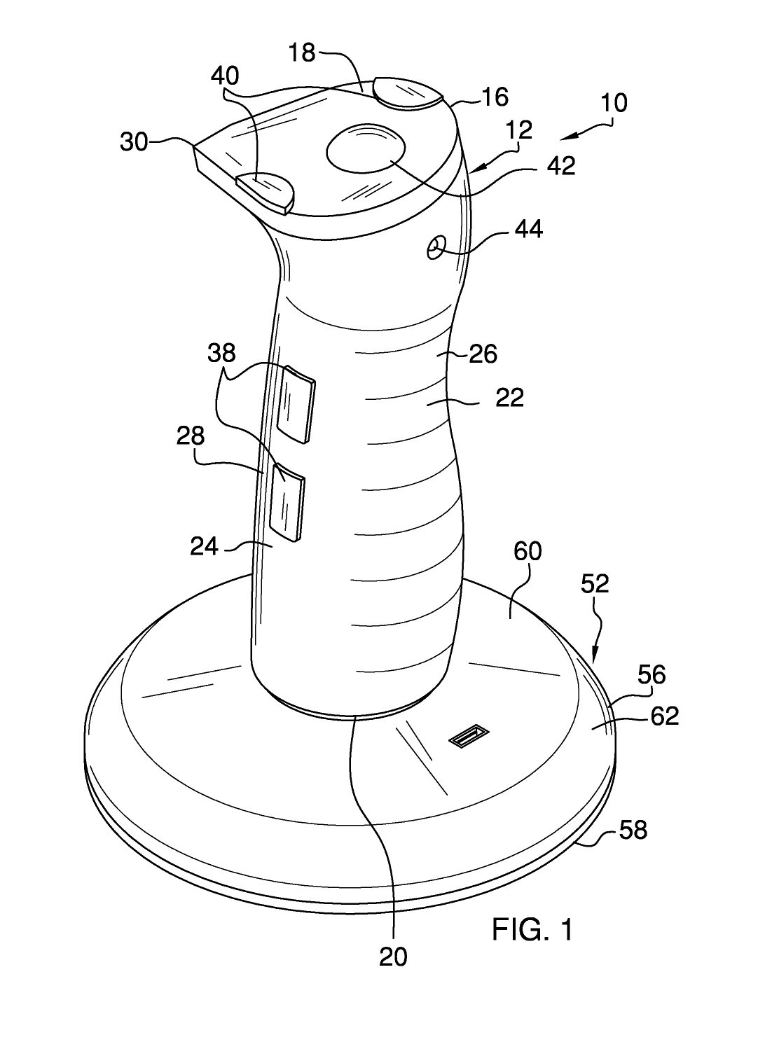

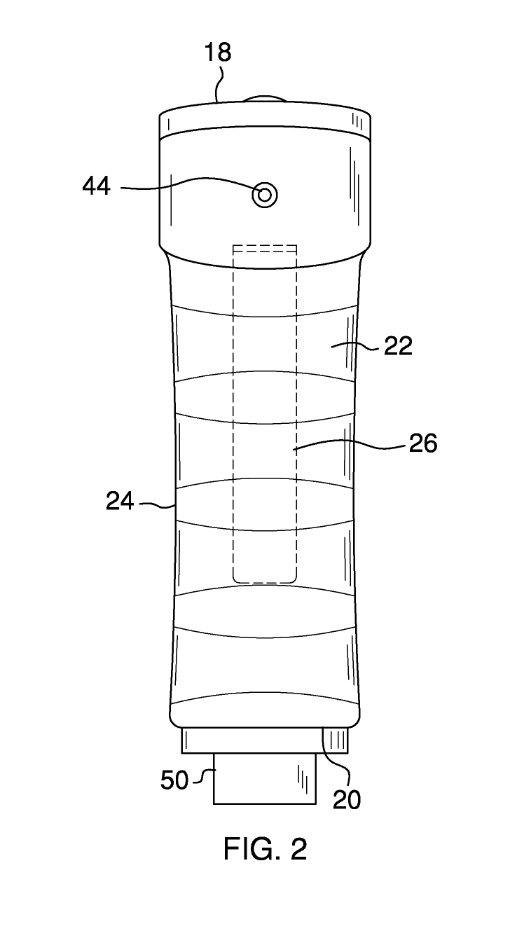

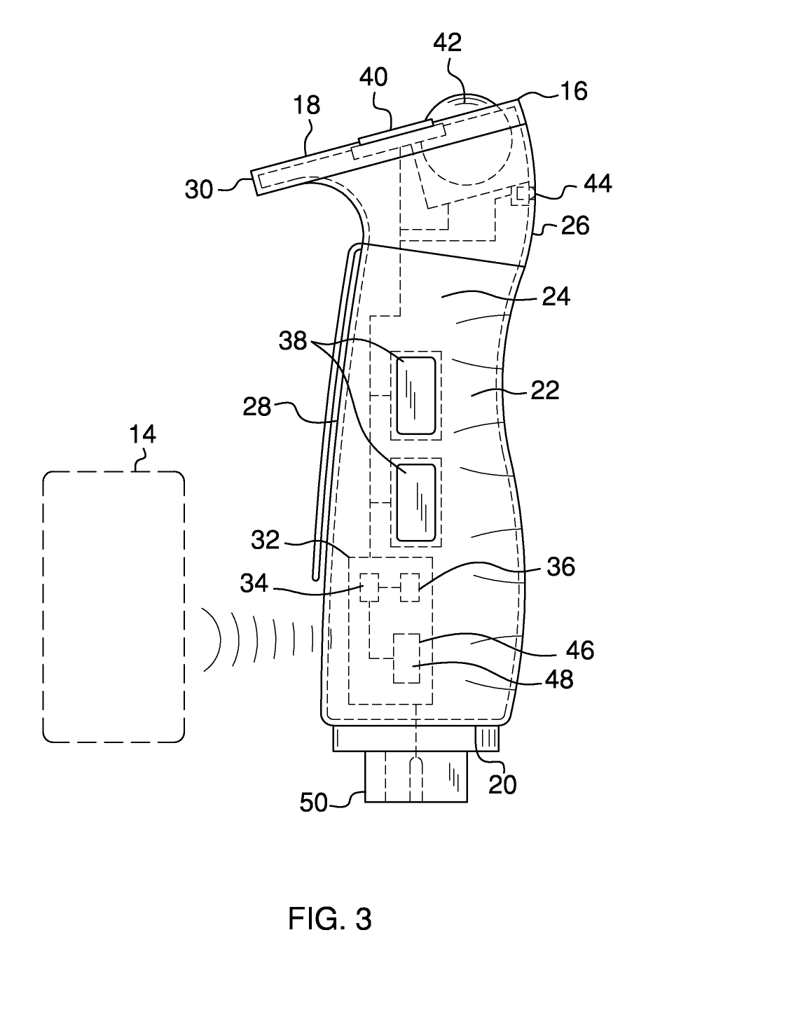

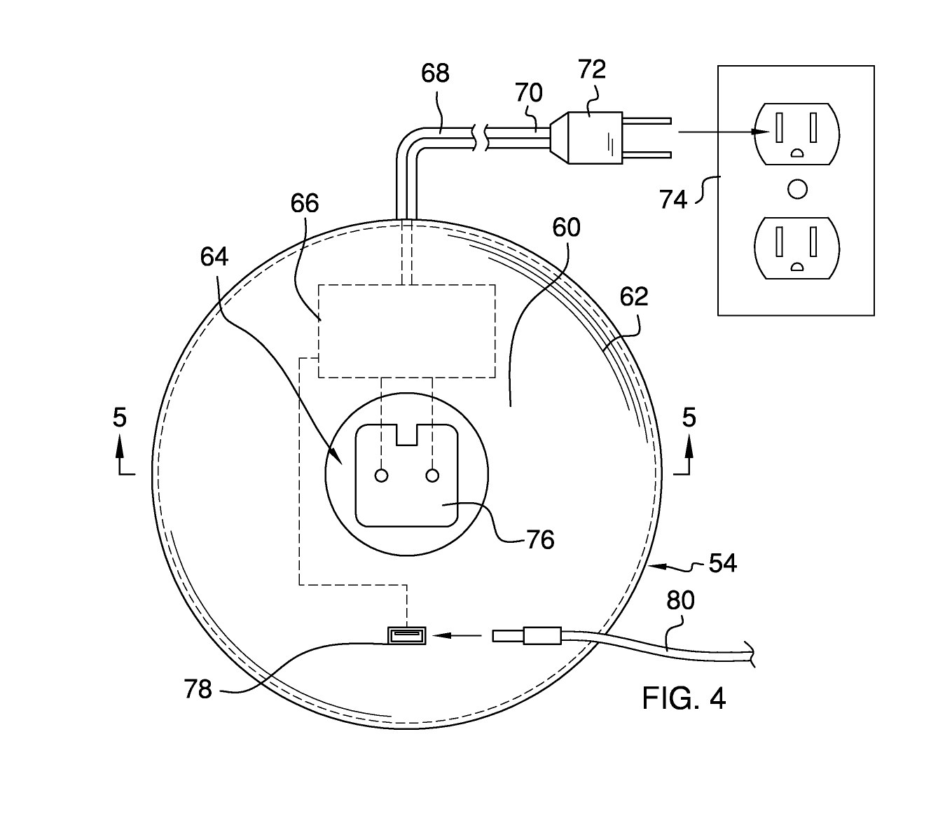

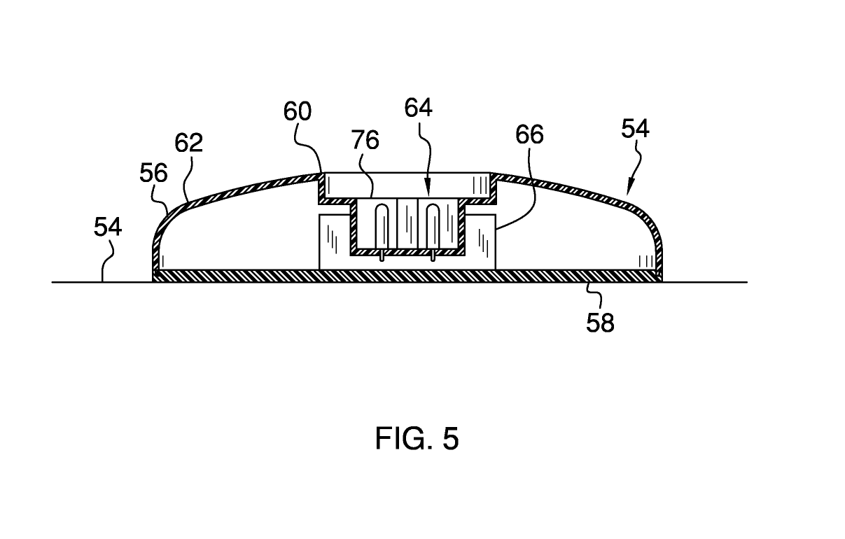

With reference now to the drawings, and in particular to FIGS. 1 through 5 thereof, a new control device embodying the principles and concepts of an embodiment of the disclosure and generally designated by the reference numeral 10 will be described.

As best illustrated in FIGS. 1 through 5, the remote control assembly 10 generally comprises a remote unit 12 that may be carried. The remote unit 12 may be in electrical communication with an extrinsic electronic device 14. The extrinsic electronic device 14 may comprise a flat screen television, a computer or other extrinsic electronic device utilized for the purposes of multimedia presentations. The remote unit 12 may be manipulated thereby facilitating the remote unit 12 to wirelessly control functions of the extrinsic electronic device 14.

The remote unit 12 comprises a grip 16 that has a top end 18, a bottom end 20 and a peripheral wall 22 extending between the top end 18 and the bottom end 20. The peripheral wall 22 is curved such that the grip 16 has a substantially cylindrical shape. The grip 16 is elongated between the top end 18 and the bottom end 20. Thus, the grip 16 may be gripped in a vertical orientation with respect to a line extending through the top end 18 and the bottom end 20. The vertical orientation of the grip 16 enhances comfort of a user while the grip 16 is gripped.

The peripheral wall 22 has a first lateral side 24, a front side 26 and a back side 28. The back side 28 curves outwardly adjacent to the top end 18 to form a horn 30 on the grip 16. The horn 30 enhances a grip of the users' thumb on the grip 16. The front side 26 undulates between the bottom end 20 and the top end 18. Thus, the front side 26 enhances a grip of the user's fingers on the grip 16.

A control circuit 32 is positioned within the grip 16. The control circuit 32 includes a processor 34 and a transmitter 36. The transmitter 36 is electrically coupled to the processor 34. The transmitter 36 may be in electrical communication with the extrinsic electronic device 14. The processor 34 may comprise an electronic processor or the like. The transmitter 36 may comprise a radio frequency transmitter or the like.

A pair of first switches 38 is provided and each of the first switches 38 is positioned on the peripheral wall 22. Each of the first switches 28 is positioned on the first lateral side 24 such that each of the first switches 28 may be manipulated. Each of the first switches 28 is electrically coupled to the processor 34. Thus, each of the first switches 28 selectively issues a command with respect to the extrinsic electronic device 14.

A pair of second switches 40 is provided and each of the second switches 40 is positioned on the top end 18. Thus, each of the second switches 40 may be manipulated. Each of the second switches 40 is electrically coupled to the processor 34. Each of the second switches 40 selectively issues a command with respect to the extrinsic electronic device 14.

A track ball 42 is rotatably coupled to the grip 16. The track ball 42 is positioned on the top end 18 such that the track ball 42 may be manipulated. The track ball 42 is electrically coupled to the processor 34. Thus, the track ball 42 selectively issues commands with respect to a cursor on the extrinsic electronic device 14. The track ball 42 is positioned between each of the second switches 40.

A light emitter 44 is positioned on the front side 26 such that the light emitter 44 selectively emits a beam of light from the front side 26. The light emitter 44 is positioned proximate the top end 18. The light emitter 44 is electrically coupled to the processor 34.

The light emitter 44 may comprise a laser pointer or the like capable of emitting a visible beam of light.

A remote power supply 46 is electrically coupled to the processor 34. The remote power supply 46 comprises at least one rechargeable battery 48. The remote power supply 46 includes a charge port 50 that is coupled to the bottom end 18. The charge port 50 is electrically coupled to the remote power supply 46.

A base unit 52 is provided and the base unit 52 may be positioned on a support surface 54. The support surface 54 may comprise a table top or the like. The base unit 52 has the remote unit 12 removably positioned thereon. Thus, the remote unit 12 may be manipulated in the convention of a joystick. The base unit 52 charges the remote unit 12 when the remote unit 12 is positioned on the base unit 52.

The base unit 52 comprises a housing 56 that has a lower side 58, an upper side 60 and a perimeter side 62 extending between the lower side 58 and the upper side 60. The lower side 58 abuts the support surface 54. The upper side 60 has a well 64 extending downwardly therein. The well 64 insertably receives the charge port 50 such that grip 16 extends upwardly from the housing 56.

A base power supply 66 is positioned within the housing 56. The base power supply 66 comprises a power cord 68 extending outwardly from the perimeter side 62. The power cord 68 is electrically coupled to the base power supply 66 and the power cord 68 has a distal end 70 with respect to the perimeter side 62. The distal end 70 has a plug 72 that is electrically coupled thereto. The plug 72 may be electrically coupled to a power source 74 and the power source 74 may comprise an electrical outlet or the like.

A socket 76 is positioned within the well 64 and the socket 76 is electrically coupled to the base power supply 66. The socket 76 insertably receives the charge port 50 when the grip 16 is positioned in the well 64. The charge port 50 is electrically coupled to the socket 76 such that the charge port 50 charges the remote power supply 46.

A power port 78 is positioned on the upper side 60. The power port 78 may be electrically coupled to a conductor 80. The conductor 80 may comprise a usb cord or the like. The power port 78 is electrically coupled is electrically coupled to the base power supply 66.

In use, the plug 72 is electrically coupled to the power source 74 and the grip 16 is positioned within the well 64 to charge the battery 48. The grip 16 may be manipulated while the grip 16 remains on the base unit 52. Each of the first switches 38, the second switches 40 and the track ball 42 may be utilized while the grip 16 remains on the base unit 52. The grip 16 may be carried in the vertical orientation thereby reducing fatigue on the user's wrist. Each of the first switches 38, the second switches 40, the track ball 42 and the light emitter 44 may be utilized while the grip 16 is being carried. The grip 16 is utilized to remotely control all functions of the extrinsic electronic device 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A remote control assembly comprising:
a remote unit configured to be carried, said remote unit being configured to be in electrical communication with an extrinsic electronic device, said remote unit being configured to be manipulated thereby facilitating said remote unit to wirelessly control functions of the extrinsic electronic device; and
a base unit being configured to be positioned on a support surface, said base unit having said remote unit being removably positioned thereon, said base unit charging said remote unit when said remote unit is positioned on said base unit.

2. The assembly according to claim 1, wherein said remote unit comprises a grip having a top end, a bottom end and a peripheral wall extending between said top end and said bottom end, said peripheral wall being curved such that said grip has a substantially cylindrical shape wherein said grip is configured to be gripped in a vertical orientation with respect to a line extending through said top end and said bottom end, said peripheral wall having a front side and a back side.

3. The assembly according to claim 2, wherein said back side curves outwardly adjacent to said top end to form a horn on said grip wherein said horn is configured to enhance a grip of said grip, front side undulating between said bottom end and said top end wherein said front side is configured to enhance a grip of said grip.

4. The assembly according to claim 1, further comprising:
said remote unit including a grip; and
a control circuit being positioned within said grip, said control circuit comprising:
a processor, and
a transmitter being electrically coupled to said processor, said transmitter being configured to be in electrical communication with the extrinsic electronic device.

5. The assembly according to claim 4, further comprising:
said grip having a peripheral wall; and
a pair of first switches, each of said first switches being positioned on said peripheral wall wherein each of said first switches is configured to be manipulated, each of said first switches being electrically coupled to said processor wherein each of said first switches is configured to selectively issue a command with respect to the extrinsic electronic device.

6. The assembly according to claim 4, further comprising:
said grip having a top end; and
a pair of second switches, each of said second switches being positioned on said top end wherein each of said second switches is configured to be manipulated, each of said second switches being electrically coupled to said processor wherein each of said second switches is configured to issued a command with respect to the extrinsic electronic device.

7. The assembly according to claim 6, further comprising a track ball being rotatably coupled to said grip, said track ball being positioned on said top end wherein said track ball is configured to be manipulated, said track ball being electrically coupled to said processor wherein said track ball is configured to issue commands with respect to a cursor on the extrinsic electronic device, said track ball being positioned between each of said second switches.

8. The assembly according to claim 4, further comprising:
said grip having a front side; and
a light emitter being positioned on said front side wherein said light emitter is configured to selectively emit a beam of light from said front side, said light emitter being electrically coupled to said processor.

9. The assembly according to claim 4, further comprising:
said grip having a bottom end; and
a remote power supply being electrically coupled to said processor, said remote power supply comprising at least one battery, said remote power supply including a charge port being coupled to said bottom end, said charge port being electrically coupled to said remote power supply.

10. The assembly according to claim 1, wherein said base unit comprises a housing having a lower side, an upper side and a perimeter side extending between said lower side and said upper side, said lower side being configured to abut a support surface, said upper side having a well extending downwardly therein, said well insertably receiving said charge port such that grip extends upwardly from said housing.

11. The assembly according to claim 10, further comprising a base power supply being positioned within said housing, said base power supply comprising a power cord extending outwardly from said perimeter side, said power cord being electrically coupled to said base power supply, said power cord having a distal end with respect to said perimeter side, said distal end having a plug being electrically coupled thereto, said plug being configured to be electrically coupled to a power source.

12. The assembly according to claim 11, further comprising:
a grip having a charge port and a remote power supply; and
a socket being positioned within said well, said socket being electrically coupled to said base power supply, said socket insertably receiving said charge port when said grip is positioned in said well, said charge port being electrically coupled to said socket such that said charge port charges said remote power supply.

13. The assembly according to claim 11, further comprising a power port being positioned on said upper side wherein said power port is configured to be electrically coupled to a conductor, said power port being electrically coupled being electrically coupled to said base power supply.

14. A remote control assembly comprising:
a remote unit configured to be carried, said remote unit being configured to be in electrical communication with an extrinsic electronic device, said remote unit being configured to be manipulated thereby facilitating said remote unit to wirelessly control functions of the extrinsic electronic device, said remote unit comprising:
a grip having a top end, a bottom end and a peripheral wall extending between said top end and said bottom end, said peripheral wall being curved such that said grip has a substantially cylindrical shape wherein said grip is configured to be gripped in a vertical orientation with respect to a line extending through said top end and said bottom end, said peripheral wall having a front side and a back side, said back side curving outwardly adjacent to said top end to form a horn on said grip wherein said horn is configured to enhance a grip of said grip, front side undulating between said bottom end and said top end wherein said front side is configured to enhance a grip of said grip,
a control circuit being positioned within said grip, said control circuit comprising:
a processor,
a transmitter being electrically coupled to said processor, said transmitter being configured to be in electrical communication with the extrinsic electronic device,
a pair of first switches, each of said first switches being positioned on said peripheral wall wherein each of said first switches is configured to be manipulated, each of said first switches being electrically coupled to said processor wherein each of said first switches is configured to selectively issue a command with respect to the extrinsic electronic device,
a pair of second switches, each of said second switches being positioned on said top end wherein each of said second switches is configured to be manipulated, each of said second switches being electrically coupled to said processor wherein each of said second switches is configured to issued a command with respect to the extrinsic electronic device,
a track ball being rotatably coupled to said grip, said track ball being positioned on said top end wherein said track ball is configured to be manipulated, said track ball being electrically coupled to said processor wherein said track ball is configured to issue commands with respect to a cursor on the extrinsic electronic device, said track ball being positioned between each of said second switches,
a light emitter being positioned on said front side wherein said light emitter is configured to selectively emit a beam of light from said front side, said light emitter being electrically coupled to said processor, and
a remote power supply being electrically coupled to said processor, said remote power supply comprising at least one battery, said remote power supply including a charge port being coupled to said bottom end, said charge port being electrically coupled to said remote power supply; and
a base unit being configured to be positioned on a support surface, said base unit having said remote unit being removably positioned thereon, said base unit charging said remote unit when said remote unit is positioned on said base unit, said base unit comprising:
a housing having a lower side, an upper side and a perimeter side extending between said lower side and said upper side, said lower side being configured to abut a support surface, said upper side having a well extending downwardly therein, said well insertably receiving said charge port such that grip extends upwardly from said housing,
a base power supply being positioned within said housing, said base power supply comprising:
a power cord extending outwardly from said perimeter side, said power cord being electrically coupled to said base power supply, said power cord having a distal end with respect to said perimeter side, said distal end having a plug being electrically coupled thereto, said plug being configured to be electrically coupled to a power source,
a socket being positioned within said well, said socket being electrically coupled to said base power supply, said socket insertably receiving said charge port when said grip is positioned in said well, said charge port being electrically coupled to said socket such that said charge port charges said remote power supply, and
a power port being positioned on said upper side wherein said power port is configured to be electrically coupled to a conductor, said power port being electrically coupled being electrically coupled to said base power supply.
